(19) United States
(12) Patent Application Publication
(10) Pub. No.: US 2022/0350052 A1
(43) Pub. Date: Nov. 3, 2022

(54) ANTI-REFLECTION ENERGY-SAVING FILM STRUCTURE AND METHOD FOR MANUFACTURING THE SAME

(71) Applicant: NAN YA PLASTICS CORPORATION, Taipei (TW)

(72) Inventors: TE-CHAO LIAO, TAIPEI (TW); CHUN-CHE TSAO, TAIPEI (TW); Tzu-Huan Wong, Hualien County (TW)

(21) Appl. No.: 17/471,582

(22) Filed: Sep. 10, 2021

(30) Foreign Application Priority Data
Apr. 30, 2021 (TW) 110115701

(51) Int. Cl. G02B 1/118

(52) U.S. Cl. CPC G02B 1/118

(57) ABSTRACT

An anti-reflection energy-saving film structure and a method for manufacturing the same are provided. The anti-reflection energy-saving film structure includes a carrier layer, a barrier layer, an anti-reflection layer, and an adhesive layer. The carrier layer has a first surface and a second surface. The barrier layer is arranged on the first surface of the carrier layer. The anti-reflection layer is arranged on the second surface of the carrier layer. The anti-reflection layer has a plurality of moth-eye structures. The plurality of moth-eye structures cover 60% to 100% of a total area of the second surface, and a top of each of the plurality of moth-eye structures is conical or arc-shaped. The adhesive layer is arranged on the barrier layer.

### CROSS-REFERENCE TO RELATED PATENT APPLICATION

This application claims the benefit of priority to Taiwan Patent Application No. 110115701, filed on Apr. 30, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a film structure and a method for manufacturing the same, and more particularly to an anti-reflection energy-saving film structure that can effectively improve a visible light reflectivity of a surface and a method for manufacturing the same.

### BACKGROUND OF THE DISCLOSURE

A thermal insulation film is a film that can absorb or reflect ultraviolet light and infrared light. When the thermal insulation film is applied to glass or other transparent materials of a vehicle or a building, through an excellent infrared blocking function thereof, the thermal insulation film can block a heat of outside air from entering the vehicle or the building, so that an interior temperature is not easily affected by an outside temperature. Accordingly, energy consumption of a temperature controller in the vehicle or in the building can be reduced.

A surface reflectivity of the heat insulation film is usually greater than 10%. Therefore, when the thermal insulation film is applied to a side of the glass that corresponds to an interior of the vehicle or the building, a glare or other problems are caused, resulting in a loss of comfort for a user.

Moreover, when the temperature inside the vehicle or the building is higher than that outside the vehicle or the building, a surface of the thermal insulation film often fogs up due to water condensation, so that the user's view of the outside environment is obstructed. Accordingly, the glass is generally heated to prevent water vapor from condensing on the surface of the thermal insulation film. However, heating the glass is energy-consuming and uneconomical.

Therefore, how to improve the structure design to overcome the above-mentioned shortcomings has become one of the important issues to be solved in the related field.

### SUMMARY OF THE DISCLOSURE

In response to the above-referenced technical inadequacies, the present disclosure provides an anti-reflection energy-saving film structure and a method for manufacturing the same.

In one aspect, the present disclosure provides an anti-reflection energy-saving film structure, which includes a carrier layer, a barrier layer, an anti-reflection layer, and an adhesive layer. The carrier layer has a first surface and a second surface. The barrier layer is arranged on the first surface of the carrier layer. The anti-reflection layer is arranged on the second surface of the carrier layer. The anti-reflection layer has a plurality of moth-eye structures, and the plurality of moth-eye structures cover 60% to 100% of a total area of the second surface. A top of each of the plurality of moth-eye structures is conical or arc-shaped. The adhesive layer is arranged on the barrier layer.

In certain embodiments, the anti-reflection layer has a hydrophilic resin, and a surface of the anti-reflection layer has a water contact angle of less than 10 degrees.

In certain embodiments, the anti-reflection layer has a hydrophobic resin, and a surface of the anti-reflection layer has a water contact angle greater than 130 degrees.

In certain embodiments, a thickness of the carrier layer is between 12 μm and 250 μm, a thickness of the barrier layer is between 1 μm and 15 μm, and a thickness of the anti-reflection layer is between 1 μm and 30 μm. A total thickness of the barrier layer, the adhesive layer, and the carrier layer is between 14 μm and 270 μm.

In certain embodiments, the anti-reflection energy-saving film structure further includes a release layer and a protection layer. The release layer is arranged on the adhesive layer. The protection layer is arranged on the anti-reflection layer.

In another aspect, the present disclosure provides a method for manufacturing an anti-reflection energy-saving film structure, which includes providing a carrier layer having a first surface and a second surface, forming a barrier layer and an anti-reflection layer respectively on the first surface and the second surface, and forming an adhesive layer on the barrier layer. The anti-reflection layer has a plurality of moth-eye structures, and the plurality of moth-eye structures cover 60% to 100% of a total area of the second surface. A top of each of the plurality of moth-eye structures is conical or arc-shaped.

In certain embodiments, the anti-reflection layer has a hydrophilic resin, and a surface of the anti-reflection layer has a water contact angle of less than 10 degrees.

In certain embodiments, the anti-reflection layer has a hydrophobic resin, and a surface of the anti-reflection layer has a water contact angle greater than 130 degrees.

In certain embodiments, a thickness of the carrier layer is between 12 μm and 250 μm, a thickness of the barrier layer is between 1 μm and 15 μm, and a thickness of the anti-reflection layer is between 1 μm and 30 μm. A total thickness of the barrier layer, the adhesive layer, and the carrier layer is between 14 μm and 270 μm.

In certain embodiments, the method for manufacturing the anti-reflection energy-saving film structure further includes forming a release layer on the adhesive layer, and forming a protection layer on the anti-reflection layer.

Therefore, one of the beneficial effects of the present disclosure is that visible light reflectivity can be effectively reduced while visibility is maintained, and a requirement of thermal insulation film application can be met in the anti-reflection energy-saving film structure provided by the present disclosure by virtue of “the anti-reflection energy-saving film structure including the carrier layer, the barrier layer, the anti-reflection layer, and the adhesive layer, the carrier layer having the first surface and the second surface, the barrier layer being arranged on the first surface of the carrier layer, the anti-reflection layer being arranged on the second surface of the carrier layer, the anti-reflection layer having the plurality of moth-eye structures, the plurality of moth-eye structures covering 60% to 100% of the total area of the second surface, the top of each of the plurality of moth-eye structures being conical or arc-shaped, and the adhesive layer being arranged on the barrier layer”.

Another one of the beneficial effects of the present disclosure is that, the method for manufacturing the anti-reflection energy-saving film structure provided by the present disclosure can be applied to an industrial process by virtue of “providing the carrier layer having the first surface and the second surface, forming the barrier layer and the anti-reflection layer respectively on the first surface and the second surface of the carrier layer, the anti-reflection layer having the plurality of moth-eye structures, the plurality of moth-eye structures covering 60% to 100% of the total area of the second surface, the top of each of the plurality of moth-eye structures being conical or arc-shaped, and forming the adhesive layer on the barrier layer”, such that the anti-reflection energy-saving film structure can be produced in large quantities.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for manufacturing an anti-reflection energy-saving film structure according to a first embodiment of the present disclosure;

FIG. 2 is a schematic view of a structure according to step S102 of the method for manufacturing the anti-reflection energy-saving film structure of the present disclosure;

FIG. 3 is a schematic view of a structure according to step S104 of the method for manufacturing the anti-reflection energy-saving film structure of the present disclosure;

FIG. 4 is an enlarged view of part IV of FIG. 3;

FIG. 5 is an electron microscopic photograph (SEM image) showing an anti-reflection layer of the anti-reflection energy-saving film structure according to the first embodiment of the present disclosure;

FIG. 6 is a schematic view of a structure of the anti-reflection energy-saving film structure according to the first embodiment of the present disclosure;

FIG. 7 is a flowchart of the method for manufacturing the anti-reflection energy-saving film structure according to a second embodiment of the present disclosure;

FIG. 8 is a schematic view of a structure according to step S108 of the method for manufacturing the anti-reflection energy-saving film structure of the present disclosure; and

FIG. 9 is a schematic view of a structure according to step S110 of the method for manufacturing the anti-reflection energy-saving film structure of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

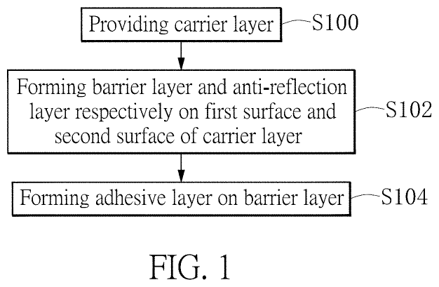

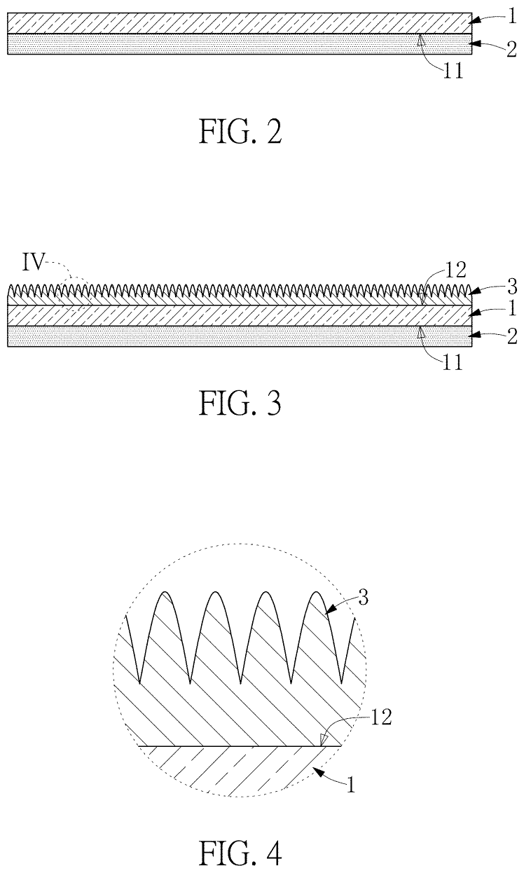

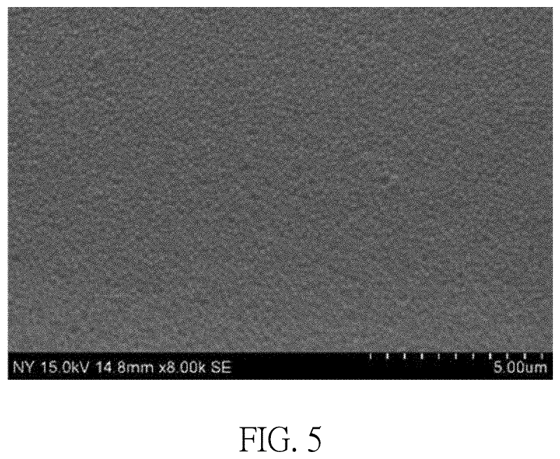

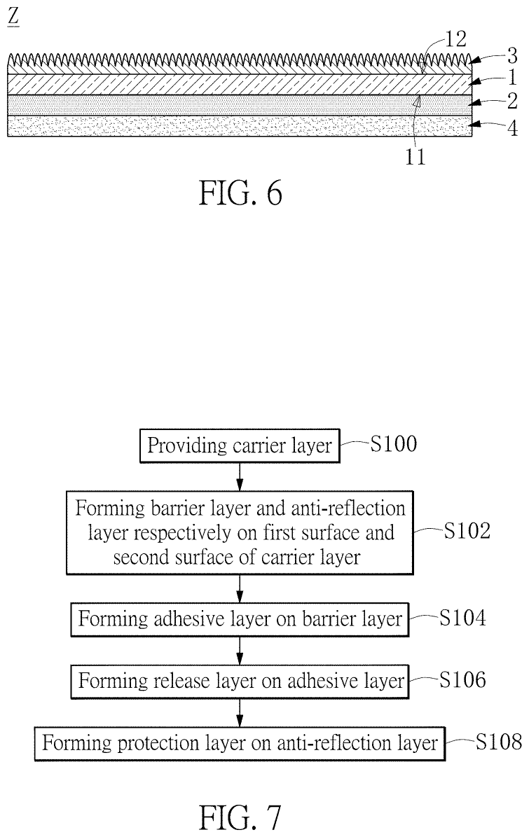

Referring to FIG. 1 to FIG. 6, FIG. 1 is a flowchart of a method for manufacturing an anti-reflection energy-saving film structure according to a first embodiment of the present disclosure, FIG. 2 is a schematic view of a structure according to step S102 of the method for manufacturing the anti-reflection energy-saving film structure of the present disclosure, FIG. 3 is a schematic view of a structure according to step S104 of the method for manufacturing the anti-reflection energy-saving film structure of the present disclosure, FIG. 4 is an enlarged view of part IV of FIG. 3, FIG. 5 is an electron microscopic photograph (SEM image) showing an anti-reflection layer of the anti-reflection energy-saving film structure according to the first embodiment of the present disclosure, and FIG. 6 is a schematic view of a structure of the anti-reflection energy-saving film structure according to the first embodiment of the present disclosure. As shown in the figures, the first embodiment of the present disclosure provides an anti-reflection energy-saving film structure Z which includes a carrier 1, a barrier layer 2, an anti-reflection layer 3, and an adhesive layer 4. Through disposing the anti-reflection layer 3 on the barrier layer 2 having a thermal insulation effect, an energy-saving effect and a glare reduction effect can be achieved at the same time in the anti-reflection energy-saving film structure Z. A method for manufacturing the anti-reflection energy-saving film structure Z of the present disclosure at least includes the following steps.

(a) Providing the carrier layer 1 (step S100). For example, as shown in FIG. 1 and FIG. 2, the carrier layer 1 of the present disclosure can be a transparent film structure, and has a first surface 11 and a second surface 12. The first surface 11 can be an upper surface of the carrier layer 1, and the second surface 12 can be a lower surface of the carrier layer 1. Alternatively, when the first surface 11 is the lower surface of the carrier layer 1, the second surface 12 can be the upper surface of the carrier layer 1. The carrier layer 1 can have a polyethylene terephthalate (PET) film or a triacetate cellulose film (TAC film having a visible light transmittance greater than 80%). A thickness of the carrier layer 1 can be between 12 μm and 250 μm, preferably between 50 μm and 75 μm, and more preferably 50 μm.

(b) Forming the barrier layer 2 and the anti-reflection layer 3 respectively on the first surface 11 and the second surface 12 of the carrier layer 1 (step S102). For example, as shown in FIG. 1 to FIG. 5, in the present disclosure the first surface 11 of the carrier layer 1 can be coated with the barrier layer 2 having an infrared blocking effect, and then the anti-reflection layer 3 is formed on the second surface 12 of the carrier layer 1 by ultraviolet (UV) transfer printing. Alternatively, the anti-reflection layer 3 is formed on the second surface 12 of the carrier layer 1 by UV transfer printing, and then the first surface 11 of the carrier layer 1 is coated with the barrier layer 2 having the infrared blocking effect. The barrier layer 2 can be a film structure, and a thickness of the barrier layer 2 is between 2 μm and 5 μm, preferably 3 μm. Based on 100 wt % of the barrier layer 2, the barrier layer 2 can have 20 wt % to 50 wt % of a resin, 15 wt % to 50 wt % of an infrared-absorbing nanoparticle, and 10 wt % to 40 wt % of a solvent. The resin can be acrylic resin, styrene maleic anhydride resin, polyurethane (PU) resin, or melamine resin. In addition, an infrared blocking rate of the barrier layer 2 is more than 70%, and an ultraviolet blocking rate of the barrier layer 2 is more than 90%. Therefore, when daylight or other light from an outside shines into a vehicle or a building, the anti-reflection energy-saving film structure Z can absorb or reflect ultraviolet and infrared light through the barrier layer 2, so that an energy-saving effect can be achieved.

When the anti-reflection layer 3 is formed by UV transfer printing, a moth-eye structure can be further formed on the anti-reflection layer 3 by imprinting, and then the anti-reflection layer 3 is cured by UV curing. The anti-reflection layer 3 has a plurality of moth-eye structures, and the plurality of moth-eye structures cover 60% to 100% of a total area of the second surface 12. A top of each of the plurality of moth-eye structures is conical or arc-shaped. The anti-reflection layer 3 can be a film structure having a hydrophilic resin or a hydrophobic resin. A thickness of the anti-reflection layer 3 can be between 1 μm and 30 μm, and preferably 5 μm. The hydrophilic resin or the hydrophobic resin can be epoxy resin, polyurethane resin, polyurethane-acrylate resin, melamine resin, phenol formaldehyde resin, or polyester resin. The hydrophilic resin is modified with a hydrophilic functional group, such as a hydroxyl terminal functional group, a glycol or other alcohol functional groups, and a hydrophilic functional group modified silicone dioxide additive on molecular structures of the above mentioned resins. The hydrophobic resin is modified with a hydrophobic functional group, such as halogen and a hydrophobic functional group modified silicone dioxide on molecular structures of the above mentioned resins. The hydrophobic resin can have 60% to 100% of a portion of the resin, and 0% to 40% of a SiO₂ nanoparticle. Furthermore, when the anti-reflection layer 3 has the hydrophilic resin, a water contact angle of a surface of the anti-reflection layer 3 is less than 10 degrees. When the anti-reflection layer 3 has the hydrophobic resin, the water contact angle of the surface of the anti-reflection layer 3 is greater than 130 degrees.

(c) Forming the adhesive layer 4 on the barrier layer 2 (step S104). For example, as shown in FIG. 1 and FIG. 6, after the anti-reflection layer 3 is formed on the carrier layer 1, the adhesive layer 4 can be formed on a surface of the barrier layer 2 that is not in contact with the carrier layer 1, such that the anti-reflection energy-saving film structure Z is obtained. The adhesive layer 4 can be an optically clear adhesive (OCA). In addition, a total thickness of the barrier layer 2, the adhesive layer 4, and the carrier layer 1 can be between 14 μm and 270 μm, and preferably between 40 μm and 170 μm.

Therefore, when the anti-reflection energy-saving film structure Z of the present disclosure is attached to a side of glass corresponding to an interior of the vehicle or the building through the adhesive layer 4, since the anti-reflection energy-saving film structure Z includes the anti-reflection layer 3 that has the moth-eye structure, a reflectivity of the anti-reflection energy-saving film structure Z is reduced to less than 1% when visible light from the interior of the vehicle or the building projects onto the anti-reflection energy-saving film structure Z. Accordingly, the reflectivity of the anti-reflection energy-saving film structure Z for the visible light can significantly and effectively be reduced, such that a problem of glare can be effectively solved and a visibility of a user can be improved.

Furthermore, the anti-reflection energy-saving film structure Z of the present disclosure can include the anti-reflection layer 3 that has the hydrophilic resin, so that water vapor can be prevented from condensing on a surface of the anti-reflection energy-saving film structure Z, thereby achieving an anti-fogging effect. Alternatively, the anti-reflection energy-saving film structure Z of the present disclosure can also include the anti-reflection layer 3 that has the hydrophobic resin, so that oil or dirt can be prevented from being attached to the surface of the anti-reflection energy-saving film structure Z, thereby achieving an anti-fouling effect.

Based on the above descriptions, the first embodiment of the present disclosure further provides an anti-reflection energy-saving film structure Z which includes the carrier layer 1, the barrier layer 2, the anti-reflection layer 3, and the adhesive layer 4. The carrier layer 1 has the first surface 11 and the second surface 12. The barrier layer 2 is arranged on the first surface 11 of the carrier layer 1. The anti-reflection layer 3 is arranged on the second surface 12 of the carrier layer 1. The anti-reflection layer 3 has the plurality of moth-eye structures. The plurality of moth-eye structures cover 60% to 100% of the total area of the second surface, and the top of each of the plurality of moth-eye structures is conical or arc-shaped. The adhesive layer 4 is arranged on the barrier layer 2.

However, the aforementioned description of the first embodiment is merely an example and is not meant to limit the scope of the present disclosure.

### Second Embodiment

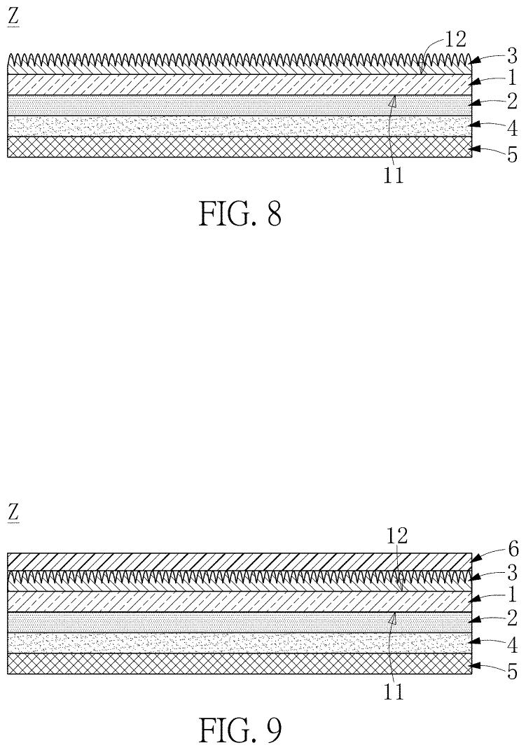

Referring to FIG. 7 to FIG. 9, in conjunction with FIG. 1 to FIG. 6, FIG. 7 is a flowchart of the method for manufacturing the anti-reflection energy-saving film structure according to a second embodiment of the present disclosure, FIG. 8 is a schematic view of a structure according to step S108 of the method for manufacturing the anti-reflection energy-saving film structure of the present disclosure, and FIG. 9 is a schematic view of a structure according to step S110 of the method for manufacturing the anti-reflection energy-saving film structure of the present disclosure. As shown in the figures, one of the differences between the second embodiment and the first embodiment of the present disclosure is that, a method for manufacturing an anti-reflection energy-saving film structure Z provided by the second embodiment of the present disclosure further includes the following steps.

(d) Forming a release layer 5 on the adhesive layer 4 (step S106). For example, as shown in FIG. 7 and FIG. 8, the release layer 5 can also be laminated onto a surface of the adhesive layer 4 that is arranged on one of two outer layers of the anti-reflection energy-saving film structure Z of the present disclosure, so as to block a contact between the adhesive layer 4 and an outside, thereby preventing the adhesive layer 4 from adhering to a foreign object. That is to say, the release layer 5 can be formed on the surface of the adhesive layer 4 that is opposite to the barrier layer 2. Furthermore, the release layer 5 can be a transparent film structure. The release layer 5 can be a PET film having a model number of L130C, and a thickness of the release layer 5 is between 19 μm and 50 μm.

(e) Forming a protection layer 6 on the anti-reflection layer 3 (step S108). As shown in FIG. 7 and FIG. 9, the protection layer 6 can also be laminated onto a surface of the anti-reflection layer 3 that is arranged on another one of the two outer layers of the anti-reflection energy-saving film structure Z of the present disclosure, so as to block a contact between the anti-reflection layer 3 and the outside, thereby preventing a damage to the anti-reflection layer 3 before being used. That is to say, the protection layer 6 can be formed on the surface of the anti-reflection layer 3 that is opposite to the carrier layer 1. In addition, the protection layer 6 can be a transparent film structure. The protection layer 6 can be a PET film having a model number of NY-325A, and a thickness of the protection layer 6 is between 19 μm and 75 μm. It should be noted that, in a preferred embodiment, the protection layer 6 and the anti-reflection layer 3 can also be formed simultaneously (as in step S104).

Therefore, when the anti-reflection energy-saving film structure Z is used, the release layer 5 can be first removed and the adhesive layer 4 is used to attach the anti-reflection energy-saving film structure Z to glass or other transparent materials. Next, the protection layer 6 is removed, so that the visible light reflectivity of the anti-reflection energy-saving film structure Z can be reduced through the anti-reflection layer 3 having the moth-eye structure.

Based on the above descriptions, the second embodiment of the present disclosure further provides an anti-reflection energy-saving film structure Z. Another one of the differences between the second embodiment and the first embodiment of the present disclosure is that, the anti-reflection energy-saving film structure Z provided by the second embodiment of the present disclosure further includes the release layer 5 and the protection layer 6. The release layer 5 is arranged on the surface of the adhesive layer 4 that is opposite to the barrier layer 2. The protection layer 6 is arranged on the surface of the anti-reflection layer 3 that is opposite to the carrier layer 1.

However, the aforementioned description of the second embodiment is merely an example and is not meant to limit the scope of the present disclosure.

### Beneficial Effects of the Embodiments

In conclusion, one of the beneficial effects of the present disclosure is that the visible light reflectivity can be effectively reduced while visibility is maintained, and a requirement of thermal insulation film application can be met in the anti-reflection energy-saving film structure Z provided by the present disclosure by virtue of “the anti-reflection energy-saving film structure Z including the carrier layer 1, the barrier layer 2, the anti-reflection layer 3, and the adhesive layer 4, the carrier layer 1 having the first surface 11 and the second surface 12, the barrier layer 2 being arranged on the first surface 11 of the carrier layer 1, the anti-reflection layer 3 being arranged on the second surface 12 of the carrier layer 1, the anti-reflection layer 3 having the plurality of moth-eye structures, the plurality of moth-eye structures covering 60% to 100% of the total area of the second surface 12, the top of each of the plurality of moth-eye structures being conical or arc-shaped, and the adhesive layer being arranged on the barrier layer”.

Another one of the beneficial effects of the present disclosure is that, the method for manufacturing the anti-reflection energy-saving film structure Z provided by the present disclosure can be applied to an industrial process by virtue of “providing the carrier layer 1 having the first surface 11 and the second surface 12, forming the barrier layer 2 and the anti-reflection layer 3 respectively on the first surface 11 and the second surface 12 of the carrier layer 1, the anti-reflection layer 3 having the plurality of moth-eye structures, the plurality of moth-eye structures covering 60% to 100% of the total area of the second surface 12, the top of each of the plurality of moth-eye structures being conical or arc-shaped, and forming the adhesive layer 4 on the barrier layer 2”, such that the anti-reflection energy-saving film structure Z can be produced in large quantities.

Furthermore, the anti-reflection energy-saving film structure Z and the method for manufacturing the same are provided by the present disclosure through the above-mentioned technical solution. When the anti-reflection energy-saving film structure Z is arranged on the side of the glass corresponding to the interior of the vehicle or the building, since the anti-reflection energy-saving film structure Z includes the anti-reflection layer 3 that has the moth-eye structure, the reflectivity of the anti-reflection energy-saving film structure Z is reduced to less than 1%, such that the problem of glare can be effectively solved. Furthermore, the anti-reflection energy-saving film structure Z of the present disclosure can include the anti-reflection layer 3 that has the hydrophilic resin, so that the water vapor can be prevented from condensing on the surface of the anti-reflection layer 3 of the outer layer of the anti-reflection energy-saving film structure Z, thereby achieving the anti-fogging effect. Alternatively, the anti-reflection energy-saving film structure Z of the present disclosure can also include the anti-reflection layer 3 that has the hydrophobic resin, so that oil or dirt can be prevented from being attached to the surface of the anti-reflection layer 3 of the outer layer of the anti-reflection energy-saving film structure Z, thereby achieving the anti-fouling effect. In addition, the method for manufacturing the anti-reflection energy-saving film structure Z can be applied to the industrial process, so that a mass production efficiency can be achieved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An anti-reflection energy-saving film structure, comprising:
a carrier layer having a first surface and a second surface;
a barrier layer arranged on the first surface of the carrier layer;
an anti-reflection layer arranged on the second surface of the carrier layer, wherein the anti-reflection layer has a plurality of moth-eye structures, the plurality of moth-eye structures cover 60% to 100% of a total area of the second surface, and a top of each of the plurality of moth-eye structures is conical or arc-shaped; and
an adhesive layer arranged on the barrier layer.

2. The anti-reflection energy-saving film structure according to claim 1, wherein the anti-reflection layer has a hydrophilic resin, and a surface of the anti-reflection layer has a water contact angle of less than 10 degrees.

3. The anti-reflection energy-saving film structure according to claim 1, wherein the anti-reflection layer has a hydrophobic resin, and a surface of the anti-reflection layer has a water contact angle greater than 130 degrees.

4. The anti-reflection energy-saving film structure according to claim 1, wherein a thickness of the carrier layer is between 12 μm and 250 μm, a thickness of the barrier layer is between 1 μm and 15 μm, a thickness of the anti-reflection layer is between 1 μm and 30 μm, and a total thickness of the barrier layer, the adhesive layer, and the carrier layer is between 14 μm and 270 μm.

5. The anti-reflection energy-saving film structure according to claim 1, further comprising:
a release layer arranged on the adhesive layer; and
a protection layer arranged on the anti-reflection layer.

6. A method for manufacturing an anti-reflection energy-saving film structure, comprising:
providing a carrier layer having a first surface and a second surface;
forming a barrier layer and an anti-reflection layer respectively on the first surface and the second surface, wherein the anti-reflection layer has a plurality of moth-eye structures, the plurality of moth-eye structures cover 60% to 100% of a total area of the second surface, and a top of each of the plurality of moth-eye structures is conical or arc-shaped; and
forming an adhesive layer on the barrier layer.

7. The method according to claim 6, wherein the anti-reflection layer has a hydrophilic resin, and a surface of the anti-reflection layer has a water contact angle of less than 10 degrees.

8. The method according to claim 6, wherein the anti-reflection layer has a hydrophobic resin, and a surface of the anti-reflection layer has a water contact angle greater than 130 degrees.

9. The method according to claim 6, wherein a thickness of the carrier layer is between 12 μm and 250 μm, a thickness of the barrier is between 1 μm and 15 μm, a thickness of the anti-reflection layer is between 1 μm and 30 μm, and a total thickness of the barrier layer, the adhesive layer, and the carrier layer is between 14 μm and 270 μm.

10. The method according to claim 6, further comprising:
forming a release layer on the adhesive layer; and
forming a protection layer on the anti-reflection layer.
